(19) United States
(12) Patent Application Publication
(10) Pub. No.: US 2011/0296345 A1
(43) Pub. Date: Dec. 1, 2011

(54) Technique For Determining And Indicating Strength Of An Item In A Weighted List Based On Tagging

(75) Inventor: Brian D. Friedman, Basking Ridge, NJ (US)

(73) Assignee: Alcatel-Lucent USA Inc., Murray Hill, NJ (US)

(21) Appl. No.: 12/788,442

(22) Filed: May 27, 2010

(51) Int. Cl. G06F 3/048

(52) U.S. Cl. 715/811

(57) ABSTRACT

A weighted list may be visually shown on a website, e.g., as a tag cloud, object cloud, etc. The font size of each item in the weighted list indicates its strength relative to the other items in the same. The strength of a weighted list item is determined based at least on individual weights associated with the users who applied a given tag to an object. For example, the item in the weighted list may represent the given tag in a tag cloud, or the object in an object cloud. The respective weights associated with the users when applying the given tag to the object may be different from one another because of different qualities of the users. For example, the weight associated with a user varies with the number of times the given tag was applied to that user.

### FIELD OF THE INVENTION

The invention relates to a data processing technique and, more particularly, to a technique for providing a weighted list (e.g., a tag cloud, an object cloud, etc.) resulting from tag applications.

### BACKGROUND OF THE INVENTION

This section introduces aspects that may help facilitate a better understanding of the invention. Accordingly, the statements of this section are to be read in this light and are not to be understood as admissions about what is prior art or what is not prior art.

Many web services allow a user to apply a tag to an object on their web page as a keyword, category label or metadata to facilitate, for example, a subsequent search for the object by the user or others. For example, upon browsing information about a person on a social network website, e.g., Facebook, users may apply one or more tags to the object person. For instance, the object person may be tagged with a label “Javascript” by users/taggers who may think the person is an expert in javascript programming language or related to javascript in whatever ways. The object person may also be tagged with a second label “Sense of Humor” by the same or different taggers who may think the person has a sense of humor, or is related to a sense of humor in whatever ways.

A weighted list, referred to as a “tag cloud,” which contains tag items representing the Javascript and Sense of Humor tags, and other tags applied by taggers to the object person, may be formed and visually shown on the website, with the tag items indicating their relative strengths. The Javascript tag item may be shown stronger than the Sense of Humor tag item if the number of taggers applying the Javascript tag is greater than that applying the Sense of Humor tag to the same object person. For example, a relatively strong tag item may be shown in a tag cloud in a relatively large font size.

Another weighted list, referred to as an “object cloud,” may also be formed, which contains items representing different objects to which the same tag, e.g., the Javascript tag, has been applied. The more times the tag has been applied to an object represented by an object item, the stronger the object item. A relatively strong object item may also be shown in a relatively large font size.

### BRIEF SUMMARY

The invention is born from the belief that increasing the accuracy of the strength of items in weighted lists (e.g., tag clouds, object clouds and other clouds) provided on a website garners credibility thereof, which is conducive to increasing traffic to the website. The strength of an item in a weighted list is determined based on applications of a given tag to an object, each of which traditionally is treated equally and accorded the same weight. However, in accordance with an embodiment of the invention, an application of the given tag to the object may be accorded a different weight than another application, thereby improving an accuracy of the item strength determination.

Thus, in accordance with an embodiment of the invention, after entries of a given tag for an object are received from users, weights associated with the users are determined, at least two of which are different from each other. A strength measure associated with the given tag for the object is then determined based at least on values of the weights. A weighted list is realizable in which an item indicates the strength measure. In one embodiment, the weight associated with a user applying the given tag to the object is based at least on the number of times the given tag was applied to that user.

### BRIEF DESCRIPTION OF THE DRAWINGS

FIG. 1 is a block diagram of a server according to an embodiment of the invention;

FIG. 2 illustrates a first web page provided by the server;

FIG. 3 illustrates a second web page provided by the server;

FIG. 4 illustrates a tag cloud provided by the server in one embodiment;

FIG. 5 is a flow chart depicting a first routine executed in the server;

FIG. 6 illustrates a second routine executed in the server;

FIG. 7 illustrates fields of a record kept in a database in the server;

FIG. 8 is a diagram depicting a relationship between taggers applying a given tag to an object in one embodiment; and

FIG. 9 illustrates an object cloud provided by the server in one embodiment.

### DETAILED DESCRIPTION

Allowing tagging of an object by applying thereto a descriptor, e.g., a short phrase, keyword, category label, metadata, etc., has become a common feature on a website. The tags applied by visitors of the website help identify the object and build a collective knowledge base about the object within a web-based application. For example, on a well known social network website like Facebook, member A may apply to member B the tag “Javascript” to indicate that member B is an expert in that particular computer language. The more members who tag member B with “Javascript,” the more likely it is, and more confident are the other members, that member B is indeed a javascript expert.

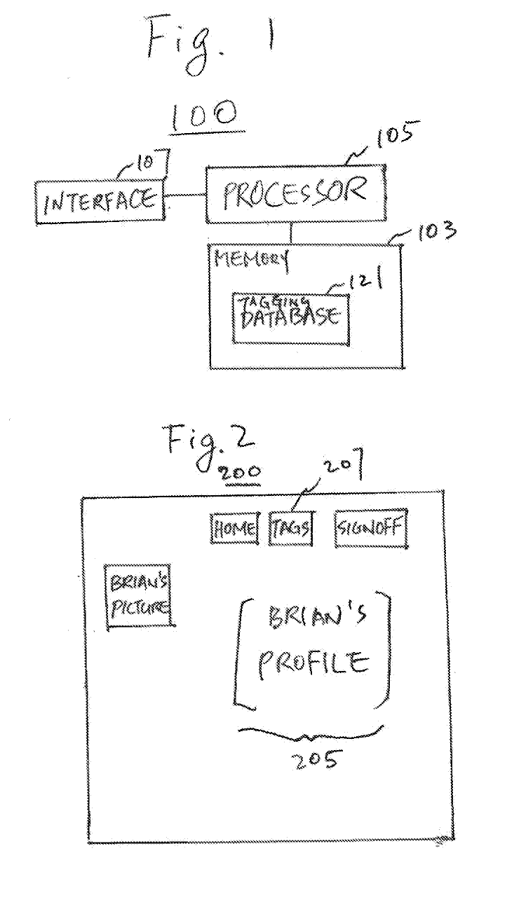

FIG. 1 illustrates a server 100 embodying the principles of the invention which may be used to provide a web service, e.g., a social-network-type service. In one embodiment, server 100 is an Apache HTTP server (also known as “Apache”) based system, whose software is stored in memory 103. As is well known, Apache affords support for such server side scripting languages as PHP hypertext preprocessor language (“PHP” in short), and such database servers as MySQL. For example, using PHP in this instance, processor 105 is programmed to provide tagging capabilities, described below, on web pages as part of the web service.

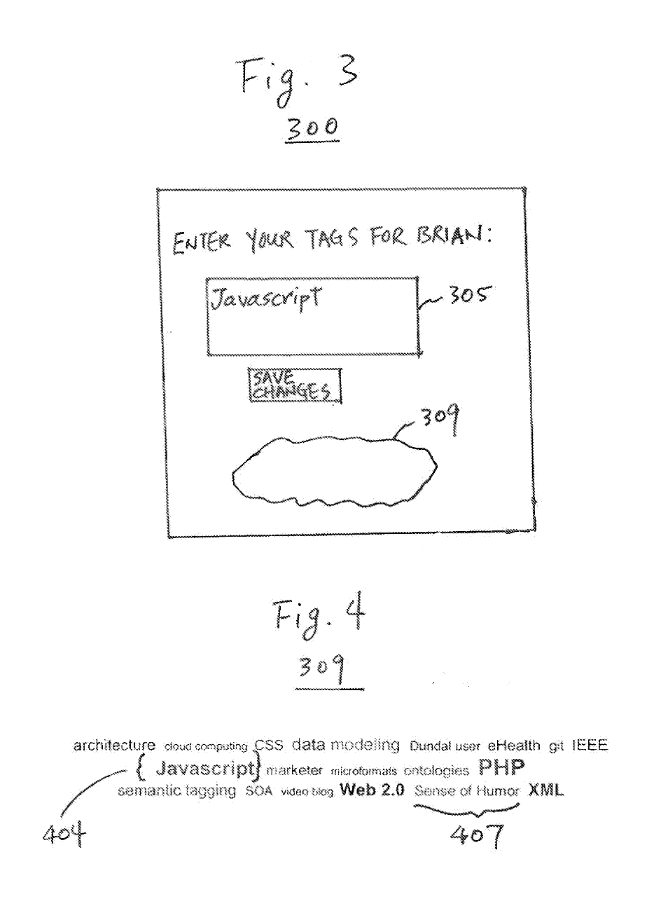

FIG. 2 illustrates one such web page 200, which is accessible to users through interface 107. For example, interface 107 may allow hypertext transfer protocol (HTTP) connections by users to server 100 via the Internet or an intranet. By way of example, but nut limitation, web page 200 includes a profile of a person named “Brian,” denoted 205, and options including a Tags option denoted 207. Selection of Tags option 207 allows a user to apply a tag descriptive of an object on web page 200, which in this instance is the person as profiled.

FIG. 3 illustrates web page 300 where the user is prompted to enter the descriptive tag after option 207 is selected. In response, the user in this instance enters in field 305 a word “Javascript” as a tag descriptive of the object person. It should be noted at this point that a person skilled in the art will appreciate that a tag may not be limited to textual form, e.g., a word or short phrase. It may be in graphical form, e.g., an icon; in audio form, e.g., a sound recording; or in any other perceptible form or a combination thereof.

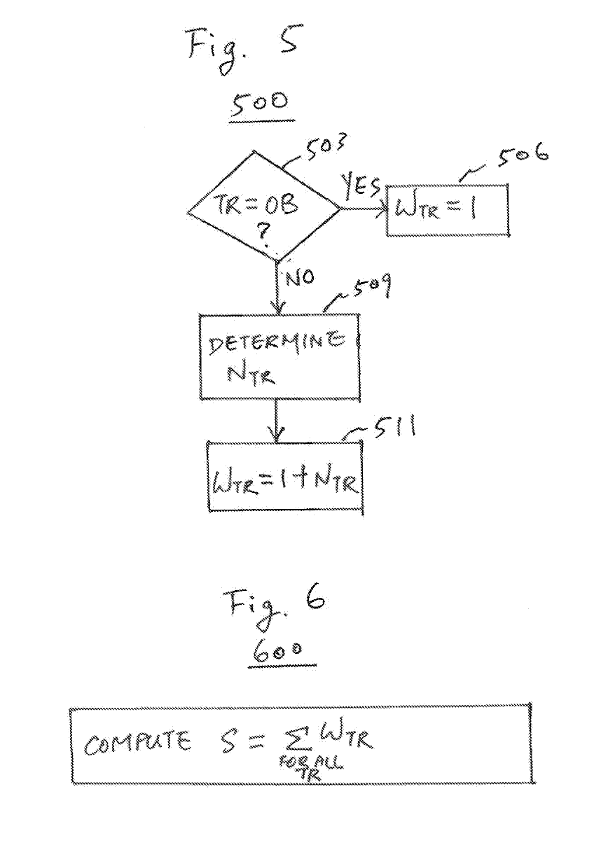

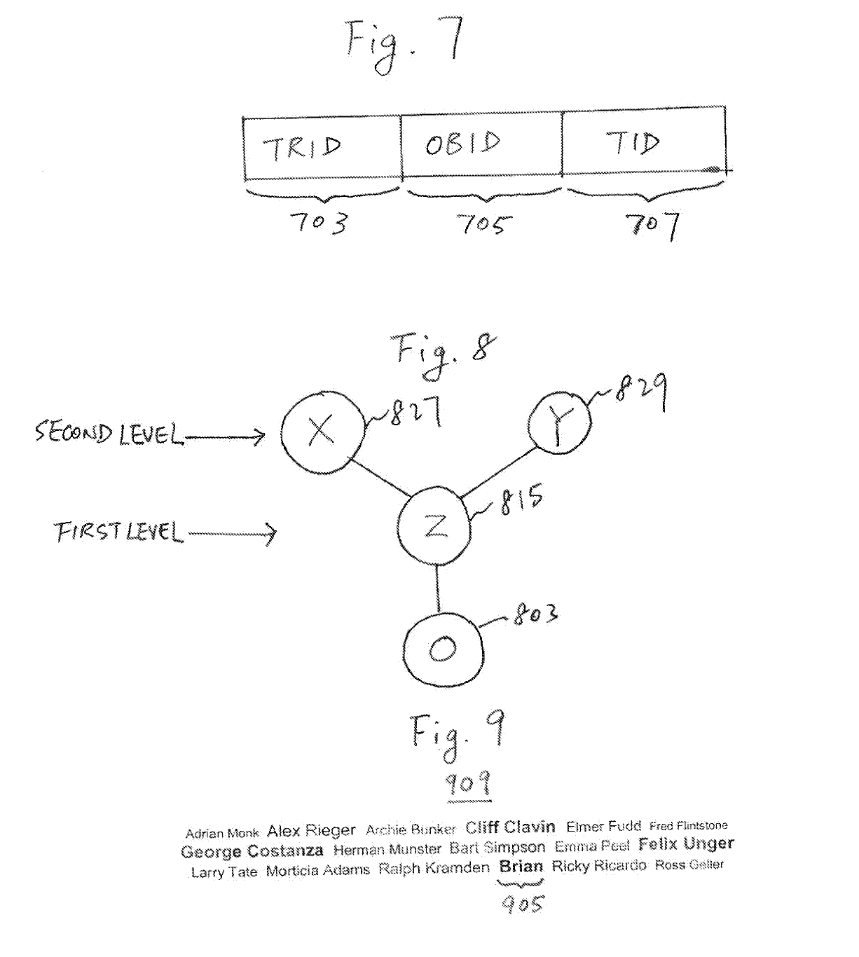

Processor 105 then determines the strength of a Javascript tag item in a weighted list, e.g., a tag cloud after the user's Javascript tag entry, and causes the tag cloud, denoted 309, to be displayed. FIG. 4 illustrates tag cloud 309, which contains Javascipt tag item 404 representing the Javascript tag and other tag items representing other tags associated with the object person. The tag items in cloud 309 indicate their respective strengths determined by processor 105. These tag items in this instance comprise hypertext markup language (HTML) elements whose display styles may be defined by a cascading style sheet (CSS) in a file (not shown) stored in memory 103.

As illustrated in FIG. 4, tag item 404 indicates its strength by its font size, relative to those of the other tag items (e.g., Sense of Humor tag item 407) in cloud 309. In this illustrative example, the stronger processor 105 determines a tag item to be, the larger font size the associated tag item shown in a tag cloud. It will be appreciated that the strengths of the tag items shown in a tag cloud may also be distinguished, e.g., by their colors, hues, shades, shadows, fonts or other visual, audio or perceptible means, or a combination thereof.

Traditionally, each application of a given tag to a particular object is treated equally and accorded the same weight. In that case, the strength of the tag item representing the given tag simply varies with the number of times the given tag was applied to the particular object. However, in accordance with an embodiment of the invention, an application of a given tag to a particular object may be accorded a different weight than another application. For instance, the actual weight accorded to an application of a given tag may depend on certain qualities of the tagger applying the given tag.

To help appreciate the invention, let's consider a simple scenario where, say, seven people applied a Javascript tag to person X, and three people applied the same Javascript tag to person Y. Now assume person Z has been tagged with “Javascript” by X, Y, and Z himself. According to the traditional method, the strength of the tag item representing the Javascript tag for person Z in that scenario would be 3 because of the three respective applications by X, Y and Z of the Javascript tag to person Z, which are treated equally. However, in accordance with an embodiment of the invention, the three applications of the Javascript tag to Z are not treated equally. Rather, they are accorded different weights associated with the taggers X, Y, and Z, respectively.

In one embodiment, the weight associated with a tagger other than the object person is 1 plus the number of times that the tagger has been tagged with a given tag, i.e., the Javascript tag in this instance. On the other hand, the weight associated with the tagger who is also the object person is always 1. The strength of the tag item representing the given tag for the object person in this embodiment equals the sum of the weights accorded to the applications of the tag, which are associated with the taggers, respectively. Thus, in the above scenario, the application by X of the Javascript tag to the object person Z is accorded the weight associated with X, which is 1+7=8. The application by Y of the Javascript tag to Z is accorded the weight associated with Y, which is 1+3−4. The application of Z of the Javascript tag to Z himself is accorded 1. Thus, the strength of the Javascript tag item for Z in that scenario is 8+4+1=13.

The invention is born from the belief that increasing the accuracy of the strength of items in weighted lists (e.g., tag clouds, object clouds and other clouds) provided on a website garners credibility thereof, which is conducive to increasing traffic to the website. In accordance with an embodiment of the invention, the more times a given tag has been applied to a person, the more weight that person carries when applying that tag to an object, as demonstrated in the above-described scenario, thereby improving the accuracy of the strength of the item representing the tag for the object. To that end, processor 105 in one embodiment determines a weight (W_{TR}) associated with each tagger TR applying the tag T to the object person OB, in accordance with routine 500 in FIG. 5. Instructed by routine 500, processor 105 at step 503 determines whether the tagger TR happens to be the object person OB, i.e., TR=OB. If so, W_{TR}=1, as indicated at step 506. Otherwise if TR OB, processor at step 509 determines the number of times (N_{TR}) tag T was applied to TR, and at step 511 determines W_{TR}1+N_{TR}.

FIG. 6 illustrates a routine, denoted 600, for processor 105 to compute the strength (S) of an item in a weighted list. In one embodiment, the weighted list is a tag cloud, and the item represents T for OB. As illustrated in FIG. 6, S equals the sum of the respective weights (W_{TR}) associated with all taggers applying T to OB.

In implementation, tagging database 121 is maintained in memory 103 in FIG. 1, which can be queried using a MySQL server (not shown) in server 100. Database 121 contains each record of an application by a tagger TR of a tag T to an object OB. FIG. 7 illustrates fields of the record which are denoted 703, 705 and 707, respectively. Specifically, field 703 of the record is referred to as a “TRID” field, which contains an identification (ID) number identifying the tagger TR. Field 705 is referred to as an “OBID” field, which contains an ID number identifying the object OB. Field 707 is referred to as a “TID” field, which contains an ID number identifying the tag T. In this particular implementation, a first table (not shown) is maintained in memory 103 for translating a TRID number or OBID number to an identity of a user of the subject service. A second table (not shown) is also maintained for translating a TID number to an actual tag, e.g., “Javascript.” Continuing the above-described scenario, when database 121 is queried using the MySQL server for records having OBID=X's ID, and TID=the ID of “Javascript,” the server returns seven records, indicating that seven taggers identified by the TRIDs in the respective records have applied the “Javascript” tag to X. Similarly, when database 121 is queried for records having OBID=Y's ID, and TID=the ID of “Javascript,” the server returns three records. Thus, by querying database 121, processor 105 can determine the N_{TR} associated with X and Y by registering the respective numbers of records returned.

After processor 105 executes routine 600 to determine that a tag item representing a given tag for an object possesses a particular S, processor 105 prepares to display the tag item in an appropriate font size reflecting its particular S. To that end, processor 105 compares the particular S with the range of S of the tag items in tag cloud 309 previously determined. For example, if the particular S is greater than the maximum S in the range, the previous mapping of the range of S to a limited number of font sizes may be revised, with the particular S now being mapped to the largest font size available, and the other Ss in the range, which are greater than a selected threshold for instance, being linearly, logarithmically or otherwise mapped to the remaining font sizes. Any Ss smaller than or equal to the selected threshold are mapped to the smallest font size. However, if processor 105 determines that the particular S is within the previous range, processor 105 uses the previous font size mapping for the particular S. In any event, once processor 105 determines the appropriate font sizes for all of the tag items in cloud 309, processor 105 sets the respective font sizes of the tag items in memory 103 accordingly, thereby realizing representations of their relative strengths in cloud 309.

The foregoing merely illustrates the principles of the invention. It will thus be appreciated that those skilled in the art will be able to devise numerous arrangements which embody the principles of the invention and are thus within its spirit and scope.

For example, in the disclosed embodiment, the strength of a tag item representing a given tag is determined based on the weight associated with each tagger applying the given tag to the object, where the weight is computed based on the number of times the same given tag was previously applied to the tagger (N_{TR}). It is anticipated that, based on the disclosure heretofore, a person skilled in the art will readily improve the accuracy of the tag item strength determination by taking into consideration not only the N_{TR} of the “first level” taggers directly applying the given tag to the object, but also the N_{TR} of the “second level” taggers applying the given tag to the first level taggers, the N_{TR} of the “third level” taggers applying the given to the second level taggers . . . , and so on and so forth. Of course, the number of levels in one such recursive process is limited by the computational expensiveness of the process which entails recursive database queries for each tagger at each level, and for each tag in the tag cloud.

An embodiment will now be described where a determination of the strength of a tag item representing a given tag based not only on the qualities of the first level taggers applying the given tag to an object, but also those of the second level taggers applying the given tag to the first level taggers (i.e., a two-level determination). This embodiment furthers the above-described scenario by now assuming Z has applied the Javascript tag to an object O, and for the sake of simplicity, Z is the only tagger who has applied such a tag to O. FIG. 8 is a tree diagram which illustrates the relationship of O, represented by root node 803, with the first level tagger Z, represented by first-level node 815, and second level taggers X and Y, represented by second-level nodes 827 and 829, respectively. As mentioned before, taggers X and Y previously applied the same Javascript tag to Z. To make the two level determination of the strength of the Javascript tag item associated with O, processor 105 queries database 121 using the MySQL server for any records having OBID=O's ID and TID=the ID of “Javascript.” In this instance, the MySQL server returns a single record having TRID=Z's ID. Having learned that Z is the only first-level tagger applying the Javascript tag to O, processor 105 queries database 121 for any records having OBID=Z's ID and TID=the ID of “Javascript.” In this instance, the MySQL server returns three records having the respective TRIDs=X's Y's ID and Z's ID, indicating that N_{TR=Z}=3. Having learned from the returned records that X and Y, different from Z, are the second level taggers, processor 105 further queries database 121 for any records having OBID=X's ID and TID=the ID of“Javascript.” In this instance, the MySQL server returns seven records, indicating that N_{TR=X}=7. Processor 105 then queries database 121 for any records having OBID=Y's ID, and TID=the ID of “Javascript.” In this instance, the MySQL server returns three records, indicating that N_{TR=Y}=3. In this two-level determination, the weight accorded to the application by Z of the Javascript tag to O is 1+N_{TR=Z}+N_{TR=X}+N_{TR=Y}=1+3+7+3=14. Since in this embodiment Z is the only tagger applying the Javascript tag to O, the strength of the tag item representing the Javascript tag for O is the same as the weight associated with Z, which equals 14, compared with that determined using the traditional method which equals 1.

In addition, weighted lists other than a tag cloud which contain items indicating their relative strengths are within the spirit and scope of the invention. In one embodiment, a weighted list is provided as an object cloud containing items representing objects to which the same tag, e.g., the Javascript tag, has been applied. FIG. 9 illustrates one such object cloud 909 on a web page, which may be accessed, e.g., by selecting Javascript tag item 404, which in this instance comprises a hyperlink to such a web page. This web page may also be accessed by searching on the tag “Javascript” on the associated website. In FIG. 9 object cloud 909 contains items representing objects, e.g., item 905 representing Brian, to which the Javascript tag has been applied. Object item 905 in this instance is in textual form and indicates its strength S computed by processor 105 according to routine 600, relative to the strengths of other object items in cloud 909 by its relative font size.

Finally, although server 100, as disclosed, is embodied in the form of various discrete functional blocks, such a server could equally well be embodied in an arrangement in which the functions of any one or more of those blocks or indeed, all of the functions thereof, are realized, for example, by one or more processors or devices.

What is claimed is:

1. An apparatus, comprising:
an interface for receiving from a plurality of users entries of a given tag for an object; and
a processor configured to determine a plurality of weights associated with the users, respectively, at least two of the weights being different from each other, a strength measure associated with the given tag for the object being determinable based at least on values of the weights, a weighted list being realizable wherein an item in the weighted list indicates the strength measure.

2. The apparatus of claim 1 wherein the item represents the given tag, and the weighted list comprises a tag cloud.

3. The apparatus of claim 1 wherein the item represents the object, and the weighted list comprises an object cloud.

4. The apparatus of claim 1 wherein the item comprises a hyperlink.

5. The apparatus of claim 1 wherein the strength measure is determined based on a sum of the plurality of weights.

6. The apparatus of claim 1 wherein the weight associated with a selected one of the users is determined based at least on the number of times the given tag was applied to associate the selected user therewith.

7. The apparatus of claim 6 wherein the given tag was applied by at least a second user to associate the selected user therewith, and the weight associated with the selected user is determined also based at least on the number of times the given tag was applied to associate the second user therewith.

8. The apparatus of claim 1 wherein the item in the weighted list is in textual form.

9. The apparatus of claim 1 wherein the strength of the given tag is indicated by a size of the item.

10. An apparatus, comprising:
an interface for receiving from a user an entry of a given tag for an object; and
a processor configured to determine a weight associated with the user, a value of the weight being based at least on the number of times the given tag was applied to associate the user therewith, a strength measure associated with the object being determinable based at least on the value of the weight, a weighted list being realizable wherein an item in the weighted list indicates the strength measure.

11. The apparatus of claim 10 wherein the given tag was applied by at least a second person to associate the user therewith, and the weight associated with the user is determined also based at least on the number of times the given tag was applied to associate the second user therewith.

12. The apparatus of claim 10 wherein the item in the weighted list is in textual form.

13. The apparatus of claim 10 wherein the strength measure is indicated by a size of the item.

14. A method for use in an apparatus for providing a weighted list, comprising:
receiving from a plurality of users entries of a given tag for the object;
for each user determining a weight associated with the user based at least on the number of times the given tag was applied to associate the user therewith;
determining a strength measure associated with the given tag based at least on the respective weights associated with the users; and
providing the weighted list, wherein an item in the weighted list indicates the strength measure.

16. The method of claim 15 wherein the item represents the given tag, and the weighted list comprises a tag cloud.

17. The apparatus of claim 15 wherein the item represents the object, and the weighted list comprises an object cloud.

18. The method of claim 15 wherein the strength measure is determined based on a sum of the weights associated with the plurality of users.

19. The method of claim 15 wherein the given tag was applied by at least a second user to associate a selected one of the users therewith, and the weight associated with the selected user is determined also based at least on the number of times the given tag was applied to associate the second user therewith.

20. The method of claim 15 wherein the item in the weighted list is in textual form.
